(19) United States
(12) Patent Application Publication
(10) Pub. No.: US 2012/0297938 A1
(43) Pub. Date: Nov. 29, 2012

(54) PLIERS WITH QUICKLY ADJUSTABLE GRIPPING JAWS

(76) Inventor: Chih-Feng Lai, Changhua City (TW)

(21) Appl. No.: 13/116,027

(22) Filed: May 26, 2011

(51) Int. Cl. B25B 7/04

(52) U.S. Cl. 81/356

(57) ABSTRACT

A pliers with quickly adjustable gripping jaws includes a first jaw and a second jaw. The first jaw is deposited on a first hand shaft. The second jaw is pivoted on a second hand shaft. An adjusting set is set up between the hand shafts. The adjusting set includes a control lever and a sliding lever. The control lever has first teeth and the sliding lever has second teeth. The first and second teeth are engaging with each other. An elastic member is located between the control lever and the second hand shaft. A spring is locked between the sliding lever and the second hand shaft. The elastic member and the spring are serving for control lever and sliding lever to back their beginning respectively. Therefore, a user only clamps the hand shafts of the pliers to adjust the gripping jaws quickly in order to clamp objects with different sizes.

### BACKGROUND OF THE INVENTION

1. Field of the Invention

The present invention relates to a pliers, more particularly to a pliers with quickly adjustable gripping jaws which a user can clamp objects with different sizes by one pliers without alternation.

2. Description of Related Art

The conventional pliers are used to hold objects firmly, for cutting, bending, or physical compression. Generally, pliers consist of a pair of metal hand shafts jointed at a fulcrum. A pair of gripping jaws is formed on one side of two metal hand shafts. In addition, the length of the gripping jaw is shorter than the length of the metal hand shaft. This arrangement creates a mechanical advantage, allowing the force of the hand's grip to be amplified and focused on an object with precision. Thus, users can easily tighten or loose objects with appropriate sizes by the conventional pliers. However, if the dimensions of an object are bigger than the dimensions of the gripping jaws, users need to choose other pliers with appropriate dimensions of the gripping jaws. It is inconvenient for users to do their work.

In order to overcome the disadvantage mentioned above, some manufacturers provide a series of gripping jaw set for users alternating on hand shafts. Therefore, the users only take gripping jaw sets with different jaw lengths instead of various pliers. However, the users need to alternate gripping jaws for objects with different sizes. Moreover, the users need to increase their forces to clamp the bigger objects when they alternate gripping jaws with longer length. Therefore, the users cannot use one pliers without any alternation to clamp objects with different sizes.

The present invention has arisen to mitigate and/or obviate the disadvantages of the conventional.

### SUMMARY OF THE INVENTION

The main objective of the present invention is to provide an improved pliers to adjust the gripping jaws quickly for clamping objects with different sizes.

To achieve the objective, a pliers with quickly adjustable gripping jaws comprises a pliers having a first jaw, a second jaw, a first hand shaft, and a second hand shaft, the first jaw deposited at one end of the first hand shaft, the second jaw pivoted on one end of the second hand shaft, an adjusting set being set up between the first hand shaft and the second hand shaft, wherein the adjusting set is driven by clamping the first hand shaft and the second hand shaft or not, the adjusting set further comprising a control lever and a sliding lever, the control lever having a plurality of first teeth, the sliding lever having a plurality of second teeth, the first teeth and the second teeth engaging with each other, wherein the control lever and the sliding lever are driven by clamping the first hand shaft and the second hand shaft or not, thereby the second teeth boosts the first teeth forward to close the first jaw and the second jaw, an elastic member located between the control lever and the second hand shaft, a spring locked between the sliding lever and the second hand shaft, the elastic member and the spring serving for control lever and sliding lever to back the initial positions respectively, wherein a user only clamps the first hand shaft and the second hand shaft of the pliers to adjust the first jaw and the second jaw quickly in order to clamp objects with different sizes, the first teeth and the second teeth being unidirectional, thereby the sliding lever only boosts the first teeth forward, a plurality of annular teeth formed on the second hand shaft, a plurality of positioning teeth formed on a bottom of a positioning block and engaging with the annular teeth to control a separation between the first jaw and the second jaw, the annular teeth and the positioning teeth both having the same amount of teeth with corresponding shapes, the elastic member being made of torsion springs and the spring being elongated, a track opened on the first hand shaft longitudinally for receiving the sliding lever, a connecting hole opened on the second jaw, the connecting hole corresponding to a pivot hole opened on the second hand shaft, a pivot rod inserted into the connecting hole and the pivot hole simultaneously to pivot the second jaw on the second hand shaft.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a pliers with quickly adjustable gripping jaws in accordance with the present invention;

FIG. 2 is an assembled view of the pliers with quickly adjustable gripping jaws in accordance with the present invention;

FIG. 3 is an assembled view for showing a cylinder clamped by the present invention;

FIG. 4 is an assembled view for showing a rectangular block clamped by the present invention;

FIG. 5 is an assembled view for showing a user pressing a control lever of the present invention;

FIG. 6 is a partial assembled view for showing a sliding lever and the control lever without engaging at the beginning;

FIG. 7 is a partial assembled view for showing the sliding lever boosting the control lever forward;

FIG. 8 is a partial assembled view for showing the sliding lever disengaging from the control lever as the user pressing the control lever.

### DETAILED DESCRIPTION OF THE INVENTION

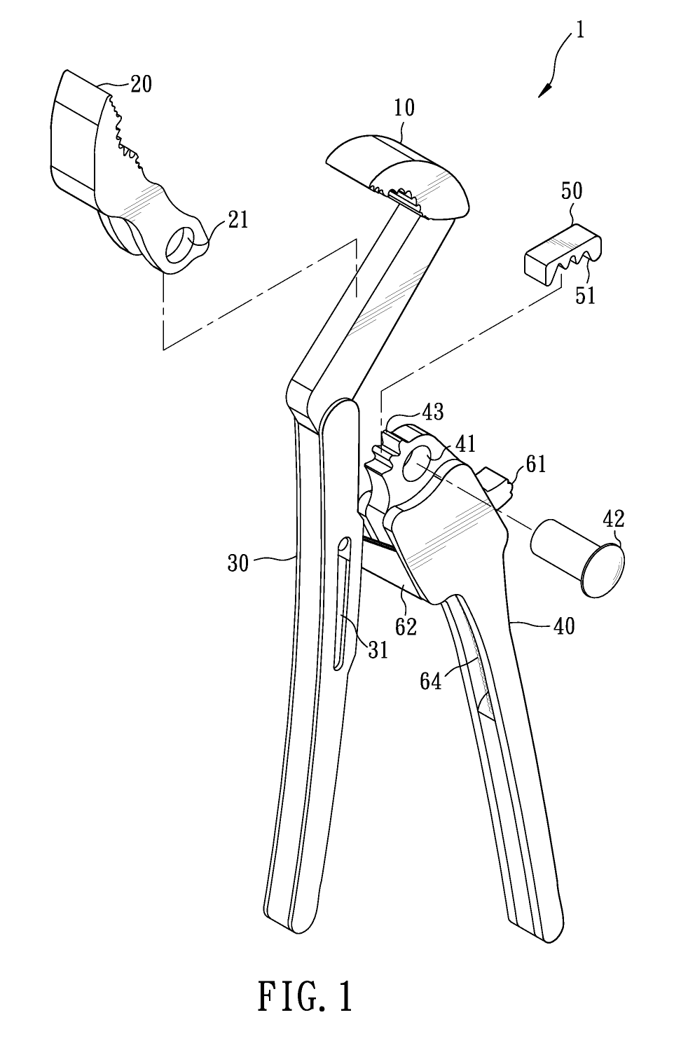

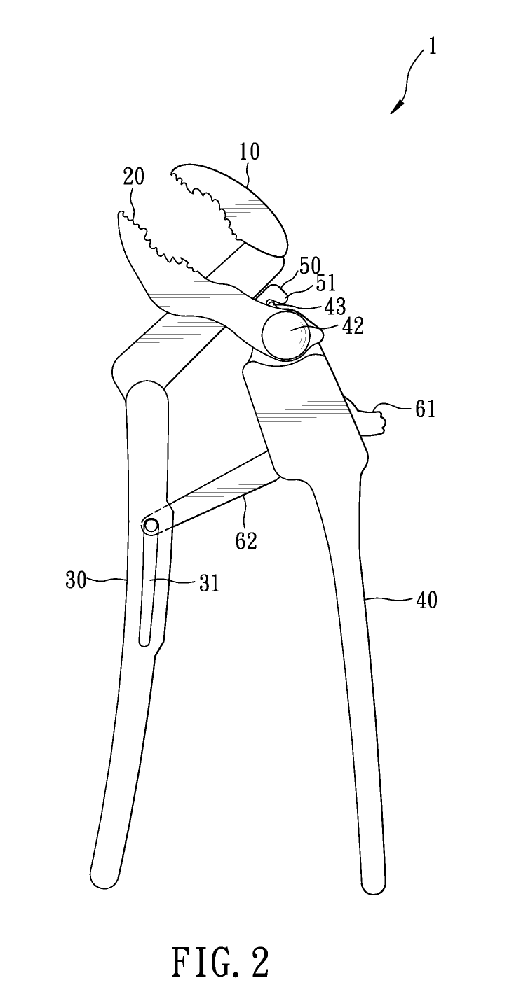

Referring to the drawings to FIGS. 1-2 and 6, a pliers with quickly adjustable gripping jaws in accordance with the present invention comprises a pliers 1 having a first jaw 10, a second jaw 20, a first hand shaft 30, and a second hand shaft 40. The first jaw 10 is deposited at one end of the first hand shaft 30. A connecting hole 21 is opened on the second jaw 20 thereof The connecting hole 21 is corresponding to a pivot hole 41 that is opened on the second hand shaft 40, and a pivot rod 42 is inserted into the connecting hole 21 and the pivot hole 41 simultaneously to pivot the second jaw 20 on the second hand shaft 40. A track 31 is opened on the first hand shaft 30 longitudinally. A plurality of annular teeth 43 are formed around the pivot hole 41 of the second hand shaft 40. A plurality of positioning teeth 51 are formed on a bottom of a positioning block 50 and are engaging with the annular teeth 43. The annular teeth 43 and the positioning teeth 51 both have the same amount of teeth with corresponding shapes. A top of the positioning block 50 is abutted against the first jaw 10.

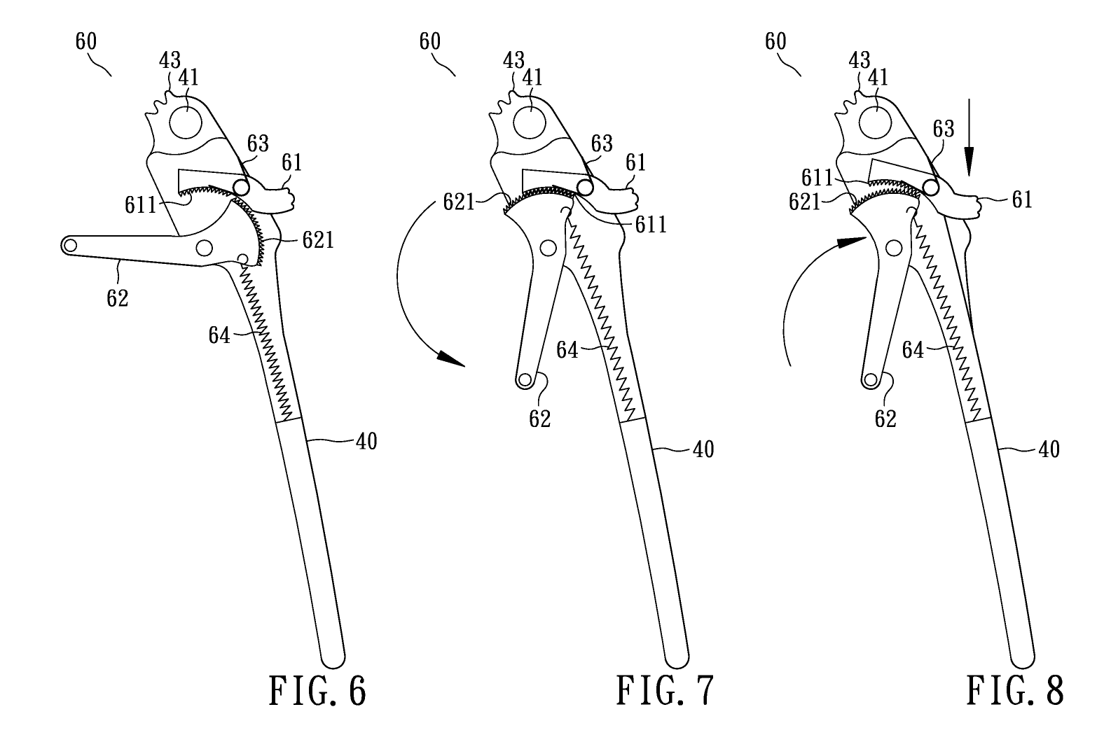

An adjusting set 60 is set up between the first hand shaft 30 and the second hand shaft 40. The adjusting set 60 is driven by clamping the first hand shaft 30 and the second hand shaft 40 or not. The adjusting set 60 further comprises a control lever 61, a sliding lever 62, an elastic member 63, and a spring 64. One portion of the control lever 61 is uncovered by the second hand shaft 40. The other portions of the control lever 61 are embedded in the second hand shaft 40. One end of the sliding lever 62 is putting into the track 31 of the first hand shaft 30. Another end of the sliding lever 62 is putting into the second hand shaft 40. The control lever 61 has a plurality of first teeth 611 and the sliding lever 62 has a plurality of second teeth 621. The first teeth 611 and the second teeth 621 are unidirectional and engaging with each other, wherein the second teeth 621 of the sliding lever 62 only move in one direction to boost the first teeth 611 of the control lever 61. The elastic member 63 is made of torsion springs and locates between the control lever 61 and the second hand shaft 40. The spring 64 is elongated. One end of the spring 64 is locked at the sliding lever 62 and another end of the spring 64 is locked at the second hand shaft 40. The elastic member 63 and the spring 64 are serving for control lever 61 and sliding lever 62 to back the initial positions respectively, as showing in FIG. 6.

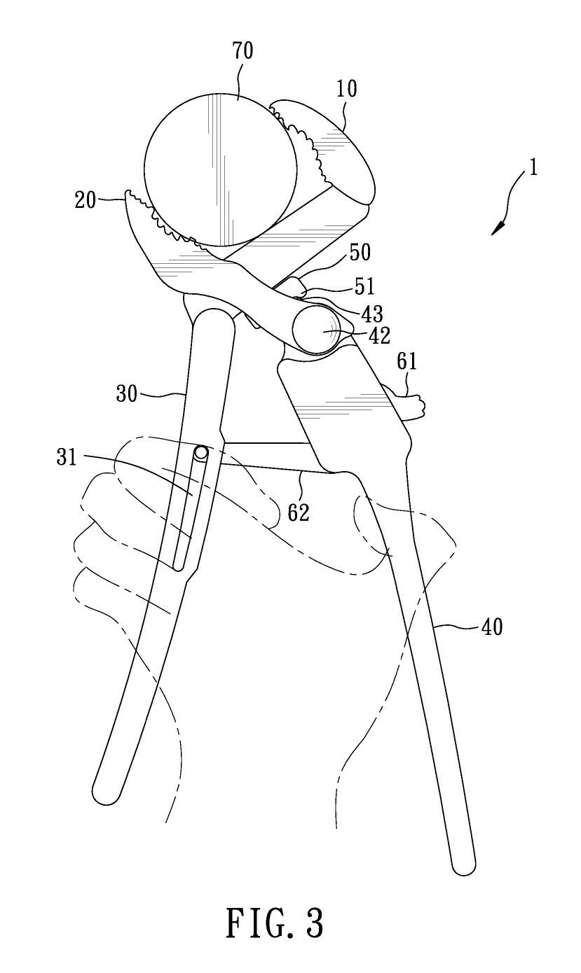

Referring to the drawings to FIGS. 3-8, when the first jaw 10 and the second jaw 20 of the pliers 1 clamp a cylinder 70 as showing in FIG. 3, a user only makes the first jaw 10 and the second jaw 20 locate at two sides of the cylinder 70, then presses the first hand shaft 30 and the second hand shaft 40. Consequently, one end of the sliding lever 62 moves downward along the track 31 and the second teeth 621 of the sliding lever 62 moves counterclockwise along the first teeth 611 of the control lever 61 to boost the first teeth 611 forward simultaneously as showing in FIG. 7. The first teeth 611 and the second teeth 621 are unidirectional so that the first teeth 611 and the second teeth 621 cannot move back each other. Therefore, after the user releases the first hand shaft 30 and the second hand shaft 40, the first jaw 10 and the second jaw 20 still clamp the cylinder 70. In addition, the top of positioning block 50 abutted against the first jaw 10 provides a force to clamp the cylinder 70 tightly.

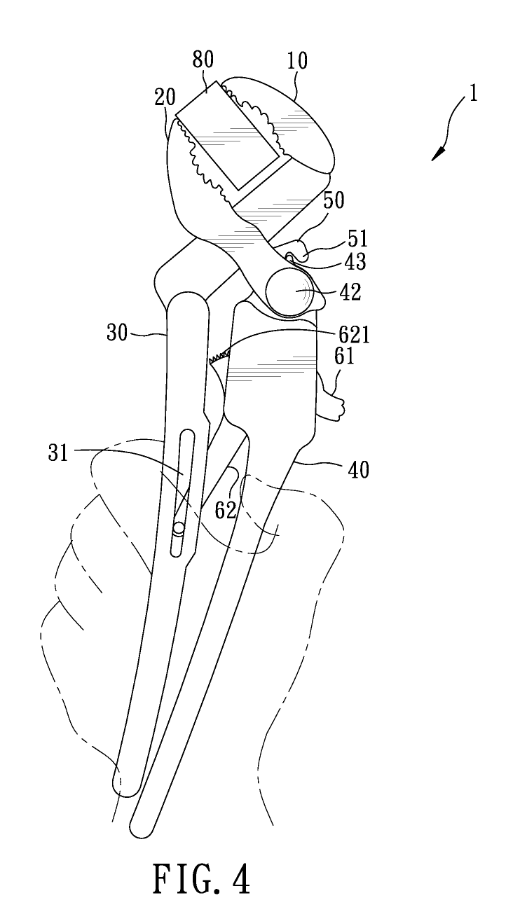

Referring to the drawings to FIGS. 4 and 7, when the first jaw 10 and the second jaw 20 of the pliers 1 clamp a rectangular block 80 which is smaller than the cylinder 70, the user keeps pressing the first hand shaft 30 and the second hand shaft 40. Consequently, the sliding lever 62 keeps moving downward along the track 31 and the second teeth 621 of the sliding lever 62 keeps moving counterclockwise along the first teeth 611 to boost the first teeth 611 forward until the first jaw 10 and the second jaw 20 fasten the rectangular block 80.

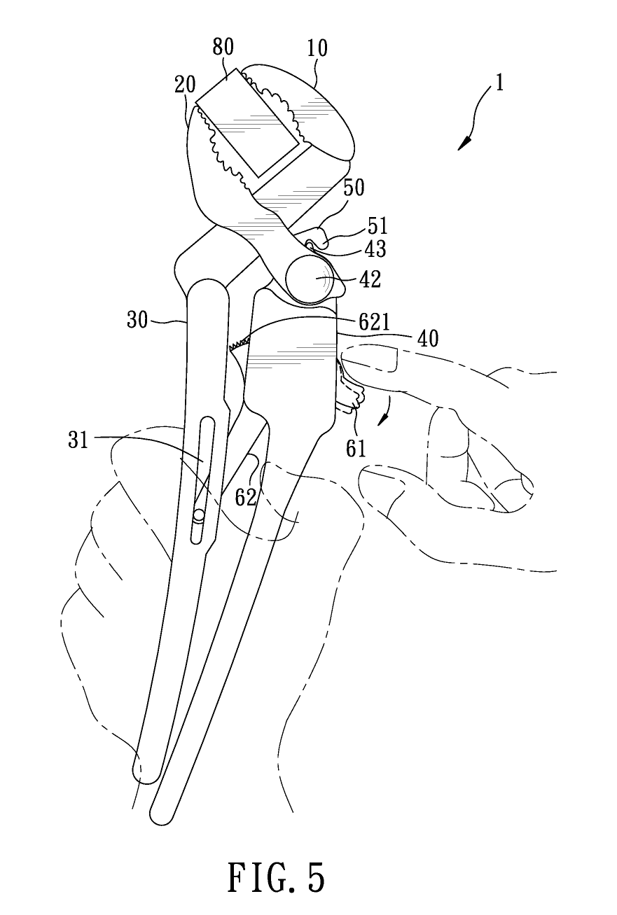

Referring to the drawings to FIGS. 5 and 8, when the user finishes clamping, the user only presses the control lever 61 down so that the first teeth 611 of the control lever 61 are disengaging from the second teeth 621 of the sliding lever 62 as showing in FIG. 8. The sliding lever 62 is pulled to an initial position by a recovering force of the spring 64. After the user releases the control lever 61, the control lever 61 is also pushed to an initial position by a recovering force of the elastic member 63. Consequently, the first jaw 10 and the second jaw 20 go back to the beginning so that the user can use the pliers to do other job again.

The present invention provides a way to quickly adjust gripping jaws of the pliers by the adjusting set 60. The user only clamps the first hand shaft 30 and the second hand shaft 40 of the pliers 1 to adjust the first jaw 10 and the second jaw 20 quickly in order to clamp objects with different sizes.

Although the invention has been explained in relation to its preferred embodiment, it is to be understood that many other possible modifications and variations can be made without departing from the spirit and scope of the invention as hereinafter claimed.

What is claimed is:

1. A pliers with quickly adjustable gripping jaws comprising:
a pliers having a first jaw, a second jaw, a first hand shaft, and a second hand shaft, the first jaw deposited at one end of the first hand shaft, the second jaw pivoted on one end of the second hand shaft, an adjusting set being set up between the first hand shaft and the second hand shaft, wherein the adjusting set is driven by clamping the first hand shaft and the second hand shaft or not;
the adjusting set further comprising a control lever and a sliding lever, the control lever having a plurality of first teeth, the sliding lever having a plurality of second teeth, the first teeth and the second teeth engaging with each other, wherein the control lever and the sliding lever are driven by clamping the first hand shaft and the second hand shaft or not, thereby the second teeth boosts the first teeth forward to close the first jaw and the second jaw; and
an elastic member being located between the control lever and the second hand shaft, a spring being locked between the sliding lever and the second hand shaft, the elastic member and the spring serving for control lever and sliding lever to back the initial positions respectively;
wherein a user only clamps the first hand shaft and the second hand shaft of the pliers to adjust the first jaw and the second jaw quickly in order to clamp objects with different sizes.

2. The pliers with quickly adjustable gripping jaws as claimed in claim 1, wherein the first teeth and the second teeth are unidirectional thereby the sliding lever only boosts the first teeth forward.

3. The pliers with quickly adjustable gripping jaws as claimed in claim 1, wherein a plurality of annular teeth are formed on the second hand shaft, a plurality of positioning teeth formed on a bottom of a positioning block and engaging with the annular teeth to control a separation between the first jaw and the second jaw, the annular teeth and the positioning teeth both having the same amount of teeth with corresponding shapes.

4. The pliers with quickly adjustable gripping jaws as claimed in claim 2, wherein the annular teeth are formed on the second hand shaft, the positioning teeth formed on the bottom of the positioning block and engaging with the annular teeth to control the separation between the first jaw and the second jaw, the annular teeth and the positioning teeth both having the same amount of teeth with corresponding shapes.

5. The pliers with quickly adjustable gripping jaws as claimed in claim 1, wherein the elastic member is made of torsion springs and the spring is elongated.

6. The pliers with quickly adjustable gripping jaws as claimed in claim 1, wherein a track is opened on the first hand shaft longitudinally for receiving the sliding lever.

7. The pliers with quickly adjustable gripping jaws as claimed in claim 1, wherein a connecting hole is opened on the second jaw, the connecting hole corresponding to a pivot hole opened on the second hand shaft, a pivot rod inserted into the connecting hole and the pivot hole simultaneously to pivot the second jaw on the second hand shaft.
